(19) United States
(12) Patent Application Publication
(10) Pub. No.: US 2026/0047984 A1
(43) Pub. Date: Feb. 19, 2026

(54) BABY BOTTLE

(71) Applicant: Scott Richard Klaas, New Berlin, WI (US)

(72) Inventors: Scott Richard Klaas, New Berlin, WI (US); Michael David Hojnacki, Portland, OR (US); Alexander George Izzo, Milwaukee, WI (US); Stephen James Dieter, Oregon, WI (US); Joshua Gerald Bauer, Sun Prairie, WI (US); Michael Alan Andrew, Monona, WI (US); Douglas James Birkholz, Madison, WI (US)

(21) Appl. No.: 18/805,073

(22) Filed: Aug. 14, 2024

(51) Int. Cl. A61J 11/00; A61J 11/04

(52) U.S. Cl. CPC A61J 11/002; A61J 11/04

(57) ABSTRACT

A baby bottle for holding and delivering a fluid may include a first reservoir configured for holding the fluid, a second reservoir in fluid communication with the first reservoir, and a valve assembly disposed between the first reservoir and the second reservoir. The valve assembly is configured to enable the fluid to selectively move between the first reservoir and the second reservoir.

### FIELD OF THE DISCLOSURE

The present invention relates to a fluid container, and more specifically to a baby bottle.

### BACKGROUND OF THE DISCLOSURE

Baby bottles are commonly used to feed infants milk or formula. Baby bottles often come in different shapes and sizes to hold different amounts of fluid or offer varying ergonomic benefits. Typically, baby bottles include a bottle for holding the fluid, a nipple for delivering the fluid to the infant, and a cap to couple the nipple to the bottle. A seal is usually provided between the bottle and the nipple/cap to inhibit any leaking of the fluid from the baby bottle.

### SUMMARY OF THE INVENTION

When consuming milk, formula, and/or other fluids, it is often recommended for human babies to consume only a certain amount of fluid (e.g., ½ ounce serving, 1 ounce serving, 2 ounces serving, etc.) before being burped or otherwise taking a feeding break. However, baby bottles often are filled with multiple servings at once to avoid having to refill the baby bottle multiple times during a feeding (i.e., refilling the baby bottle after each burping/break during a feeding). Additionally, it can be difficult for a user holding and feeding the baby to keep track of how much fluid the baby has consumed, which may result in the baby being overfed and/or spitting up previously consumed fluid.

To address the above-noted problems, disclosed is a baby bottle that includes two fluid reservoirs to allow a user feeding a baby to control an amount of fluid from a larger reservoir into a smaller reservoir for feeding the baby. Once the baby finishes the fluid in the smaller reservoir, the baby can be burped or otherwise take a brief feeding break, and the user may repeat the process to add more fluid from the larger reservoir into the smaller reservoir for additional feeding of the baby. In some instances, an attachment/cap is disclosed that separates an off-the-shelf baby bottle and nipple into the two separate reservoirs in order to improve the user's control over the amount of fluid that the baby consumes between burpings/breaks. The baby bottle and attachment/cap disclosed herein allow for a certain desired amount of fluid to be portioned for a baby's consumption between burpings/feeding breaks using single-handed operation so that the baby can be held with the user's other hand/arm if desired. The baby bottle and attachment/cap disclosed herein address the above-noted problems by reducing or eliminating the chances of the baby being overfed and/or spitting up due to overconsumption of fluid without being burped or taking a feeding break.

The present invention provides, in one aspect, a baby bottle for holding and delivering a fluid, the baby bottle including: a first reservoir configured for holding the fluid; a second reservoir in fluid communication with the first reservoir; and a valve assembly disposed between the first reservoir and the second reservoir, the valve assembly configured to enable the fluid to selectively move between the first reservoir and the second reservoir.

In addition to any combination of features described above, the first reservoir defines a longitudinal axis about which a cap rotates to threadably couple to the first reservoir.

In addition to any combination of features described above, the valve assembly includes an actuator that is moveable along a direction substantially perpendicular to the longitudinal axis.

In addition to any combination of features described above, the actuator is moveable between an extended state and a depressed state using a finger of a user's hand holding the baby bottle. In addition to any combination of features described above, the actuator is biased towards the extended state.

In addition to any combination of features described above, the valve assembly includes a valve that is moveable between a first position and a second position along a direction parallel to the longitudinal axis. In addition to any combination of features described above, the fluid is inhibited from moving between the first reservoir and the second reservoir when the valve is in the first position. In addition to any combination of features described above, the fluid is permitted to move between the first reservoir and the second reservoir under gravitation force when the valve is in the second position.

In addition to any combination of features described above, the valve assembly includes a cammed body that slides against the valve to move the valve between the first position and the second position.

In addition to any combination of features described above, the second reservoir includes a nipple, the nipple having at least one discharge port through which the fluid may exit the second reservoir and a check valve through which air may enter the second reservoir.

The present invention provides, in another aspect, a baby bottle for holding and delivering a fluid, the baby bottle including: a bottle defining a longitudinal axis and a first reservoir; a cap removably coupled to the bottle; a nipple defining a second reservoir that is in fluid communication with the first reservoir; and a valve assembly disposed in the cap, the valve assembly including a valve that is moveable between a first position, in which the fluid is inhibited from moving between the first reservoir and the second reservoir, and a second position, in which the fluid is permitted to move between the first reservoir and the second reservoir under gravitation force.

In addition to any combination of features described above, the nipple forms a seal with the cap.

In addition to any combination of features described above, the valve assembly is removably coupled to the cap.

In addition to any combination of features described above, the valve is moveable along a direction parallel to the longitudinal axis.

In addition to any combination of features described above, the valve is a poppet-style valve.

In addition to any combination of features described above, the valve assembly further includes an actuator that moves a direction substantially perpendicular to the longitudinal axis, and a cammed body that moves in response to movement of the actuator and slides against the valve to move the valve between the first position and the second position.

In addition to any combination of features described above, the actuator is movable between an extended state and a depressed state using a finger of a user's hand holding the baby bottle. In addition to any combination of features described above, the actuator is biased towards the extended state.

In addition to any combination of features described above, the valve includes a stem with an aperture. In addition to any combination of features described above, the cammed body slides against an inner periphery of the aperture when moving the valve between the first position and the second position.

In addition to any combination of features described above, the actuator extends through the cap.

The present invention provides, in another aspect, an attachment configured to be coupled to a baby bottle for allowing a fluid to selectively move from a first reservoir of the baby bottle to a second reservoir of the baby bottle, the attachment including: an attachment housing configured to be coupled between the first reservoir and the second reservoir; and a valve assembly disposed in the attachment housing, wherein the valve assembly includes: a main body configured to be removably coupled to the attachment housing; a valve coupled to the main body and configured to be disposed between the first reservoir and the second reservoir of the baby bottle, wherein the valve is moveable between a closed position and an open position; and an actuator coupled to the main body and configured to move the valve between the closed position and the open position.

In addition to any combination of features described above, the main body defines a longitudinal axis along which the valve moves between the closed position, in which the valve seats against the main body, and the open position, in which the valve is spaced away from the main body.

In addition to any combination of features described above, the main body includes a guide and the valve includes a stem that slides within the guide when the valve moves between the closed position and the open position.

In addition to any combination of features described above, the actuator is coupled to a cammed body that moves in response to movement of the actuator and slides against the valve to move the valve between the closed position and the open position.

Other features and aspects of the invention will become apparent by consideration of the following detailed description and accompanying drawings.

### BRIEF DESCRIPTION OF THE DRAWINGS

FIG. 1 is a perspective view of a baby bottle in accordance with an embodiment of the invention.

FIG. 2 is an exploded view of the baby bottle of FIG. 1, illustrating a bottle, a nipple, a cap, and a valve assembly.

FIG. 3 is an exploded view of the valve assembly of FIG. 2, illustrating a main body, a valve, an actuator, and a cammed body.

FIG. 4 is an enlarged cross-sectional view of the baby bottle along line 4-4 of FIG. 1, illustrating the valve assembly in a first, closed position.

FIG. 5 is an enlarged cross-sectional view of the baby bottle along line 4-4 of FIG. 1, illustrating the valve assembly in a second, open position.

FIG. 6 is a perspective view of a baby bottle in accordance with another embodiment of the invention.

FIG. 7 is an exploded view of the baby bottle of FIG. 6, illustrating a bottle, a nipple, a cap, and a valve assembly.

FIG. 8 is an enlarged cross-sectional view of the baby bottle along line 8-8 of FIG. 6, illustrating the valve assembly in a first, closed position.

FIG. 9 is an enlarged cross-sectional view of the baby bottle along line 8-8 of FIG. 6, illustrating the valve assembly in a second, open position.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

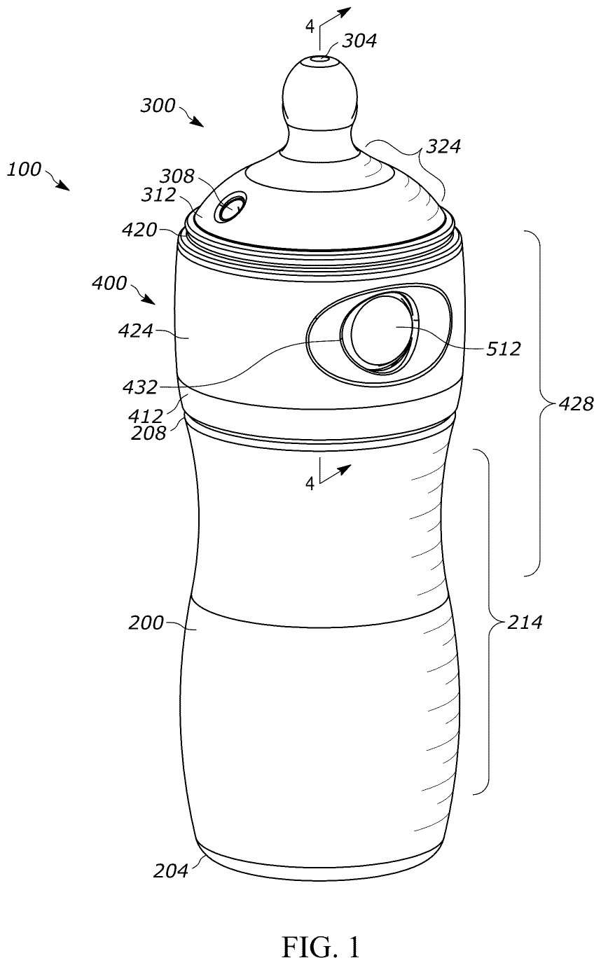

FIG. 1 illustrates a baby bottle 100 that is configured to hold and deliver fluid (e.g., milk, baby formula, etc.) to an infant. The baby bottle 100 of the illustrated embodiment includes a bottle 200, a nipple 300, and a cap 400. The bottle 200 holds and stores any fluid in the baby bottle 100, while the nipple 300 is configured to discharge the fluid from the baby bottle 100. Specifically, when the baby bottle 100 is inverted (e.g., held substantially upside down—opposite orientation to that shown in FIG. 1), the nipple 300 may deliver the fluid to an infant. That is, the illustrated baby bottle 100 is a gravity-fed baby bottle, rather than a straw-fed baby bottle. The cap 400 couples the nipple 300 to the bottle 200 and forms a water-tight seal therebetween.

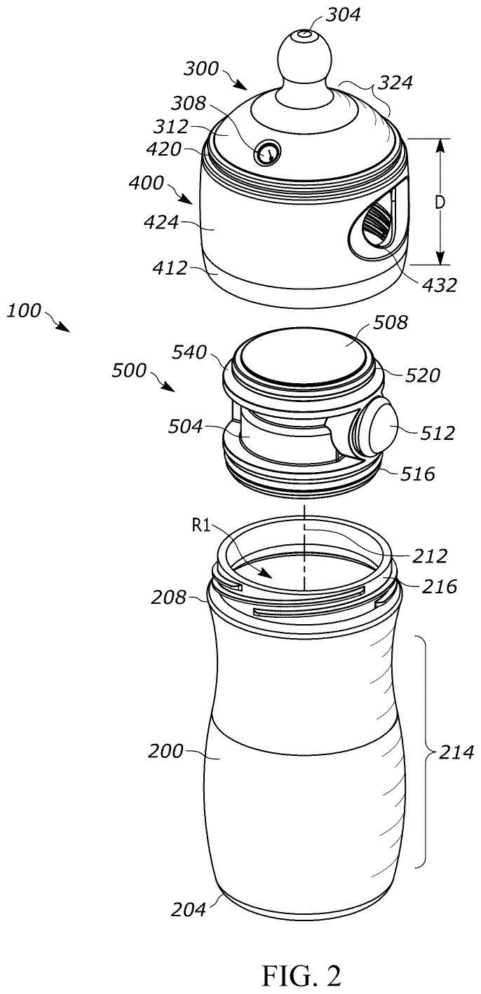

With reference to FIGS. 1 and 2, the bottle 200 includes a closed or first end 204, an open or second end 208, and measurement indices 214 (i.e., graduated markings) disposed along an outer periphery of the bottle 200 and extending in a direction from the first end 204 to the second end 208. The bottle 200 also defines a longitudinal axis 212 extending between the first end 204 and the second end 208. In the illustrated embodiment, the measurement indices 214 generally extend in a direction parallel to the longitudinal axis 212. The bottle 200 also includes a threaded region 216 adjacent the second end 208 for threadably mating with the cap 400. In other embodiments, the bottle 200 and the cap 400 may be coupled together via other mechanisms, such as a snap-fit coupling, a bayonet-style coupling, a ball-and-sleeve coupling, and other similar quick-disconnect mechanisms. In some instances, bottle 200 may be an off-the-shelf bottle and the nipple 300 may be an off-the-shelf nipple that are configured to mechanically attach to each other without the cap 400 therebetween. Accordingly, in some instances, the cap 400 is designed to match the connection mechanisms of an off-the-shelf bottle and an off-the-shelf nipple to optionally connect between the bottle 200 and the nipple 300 to form two separate reservoirs as described herein.

The bottle 200 of the illustrated embodiment is composed of hard plastic. Specifically, the bottle 200 is composed of polypropylene, while in other embodiments, the bottle 200 may alternatively be composed of glass, stainless steel, or other suitable materials. Still, in other embodiments, the bottle 200 may be deformable and may be composed of a flexible material, such as silicone or other suitable materials.

With continued reference to FIGS. 1 and 2, the nipple 300 includes a discharge port 304 through which the fluid in the bottle 200 may pass through. The discharge port 304 may be a single pinhole, slot, a plurality of pinholes, or a combination thereof. The nipple 300 also includes a check valve 308 that selectively allows air from the atmosphere surrounding the baby bottle 100 to enter inside the baby bottle 100. The check valve 308 is a one-way, duckbill style check valve that allows air to enter the baby bottle 100 as the fluid is discharged from the baby bottle 100 to balance pressure differentials between inside the baby bottle 100 and outside the baby bottle 100. Specifically, the check valve 308 opens when the pressure inside the baby bottle 100 is less than the pressure outside the baby bottle 100 (i.e., atmosphere), allowing air to enter the baby bottle 100.

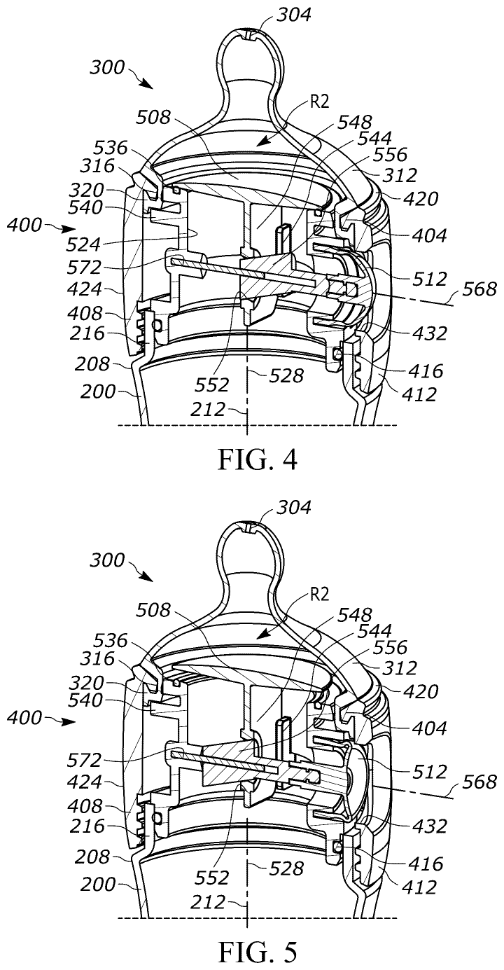

The nipple 300 also includes a base 312, a groove 316, and a flange 320. Both the groove 316 and the flange 320 extend circumferentially around the base 312. The groove 316 extends radially inward relative to the flange 320 and receives a portion of the cap 400. That is, the nipple 300 couples to the cap 400 via engagement between the groove 316 and a corresponding projection 404 of the cap 400 (as best shown in FIG. 4). As explained in further detail below, the flange 320 helps maintain a water-tight seal of the baby bottle 100 to inhibit leaking of any fluid. In some instances, the nipple 300 also includes measurement indices 324 extending generally between the base 312 and the discharge port 304. In the illustrated embodiment, the measurement indices 324 are inverted relative to the measurement indices 214 of the bottle 200, such that the measurement indices 324 are readable when the baby bottle 100 is inverted (e.g., during feeding). In other embodiments, the measurement indices 214, 324 are both oriented in the same direction, such that the measurement indices 214, 324 are readable when the baby bottle 100 is oriented upright.

The nipple 300 of the illustrated embodiment is composed of a polymer. Specifically, the nipple 300 is composed of silicone, while in other embodiments, the nipple 300 may alternatively be composed of latex or other suitable materials.

With continued reference to FIGS. 1 and 2, the cap 400 (i.e., attachment) includes a threaded region 408 at a first end 412 that threadably mates with the threaded region 216 of the bottle 200. That is, when first end 412 of the cap 400 is engaged with the second end 208 of the bottle 200, the cap 400 (or the bottle 200) may be rotated about the longitudinal axis 212 in a clockwise direction to threadably couple the bottle 200 and the cap 400. A seal 416 may be disposed on the inner periphery of the cap 400 adjacent the threaded region 408 that abuts against the second end 208 of the bottle 200 to form a water-tight seal therebetween. The cap 400 further includes a second end 420. The projection 404 (previously discussed as being received within the groove 316 of the nipple 300) is disposed at the second end 420. Between the first end 412 and the second end 420 is a cylindrical body 424 (i.e., attachment housing) that may at least partially form a gripping portion 428 of the baby bottle 100. The bottle 200 may also partially form the gripping portion 428. An aperture 432 is provided through the cap 400. The aperture 432, as explained in further detail below, is sized to allow a user's finger or thumb to pass through the aperture 432 at least partially. Also, the first end 412 and the second end 208 are spaced apart from each other a distance D (FIG. 2). In some embodiments, the distance D is between approximately 20 millimeters to approximately 100 millimeters. Specifically, the distance D is between approximately 40 millimeters to approximately 80 millimeters. More specifically, the distance D is approximately 46.5 millimeters.

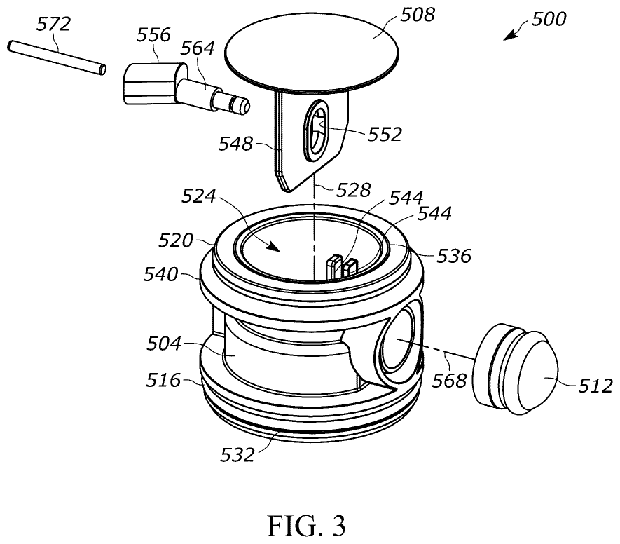

With reference to FIGS. 2 and 3, the baby bottle 100 further includes a valve assembly 500 that is removably coupled to the cap 400. The valve assembly 500 is disposed within the baby bottle 100 when the bottle 200, the nipple 300, and the cap 400 are coupled together. Generally speaking, the valve assembly 500 selectively permits the fluid in the baby bottle 100 to move from the bottle 200 toward the nipple 300, and vice versa, under gravitational force.

With reference to FIG. 3, the valve assembly 500 includes a main body 504, a valve 508 movably coupled to the main body 504, and an actuator 512 for moving the valve 508. The actuator 512 extends through the aperture 432 of the cap 400. The illustrated main body 504 includes a first end 516, a second end 520, and a passageway 524 extending between the first end 516 and the second end 520. The main body 504 defines a valve axis 528 along which the passageway 524 extends. At the first end 516 is a first seal 532 disposed on the outer periphery of the main body 504 and configured to abut against the inner periphery of the bottle 200 (near the second end 208, as best shown in FIG. 4). Furthermore, at the second end 520 is a second seal 536 that is configured to abut against the valve 508. The main body 504 also includes an annular ring 540 that extends radially outward from the main body 504. The annular ring 540 abuts against the flange 320 of the nipple 300 to create a water-tight seal between the valve assembly 500 and the nipple 300. Specifically, the flange 320 is situated (and slightly compressed) between the projection 404 of the cap 400 and the annular ring 540 to create the water-tight seal and inhibit any fluid from leaking through the interface between the nipple 300 and the cap 400.

The inner periphery of the main body 504 includes grooves or guide rails 544 that extend along a direction parallel to the valve axis 528 and the valve 508 includes a stem 548 that is slidably received within the guide rails 544. That is, the guide rails 544 constrain the valve 508 to move only axially along the valve axis 528. In other words, the guide rails 544 inhibit rotational movement of the valve 508 about the valve axis 528. The stem 548 also includes an elongated slot 552.

The valve assembly 500 further includes a cammed body 556 that is received within the elongated slot 552. The cammed body 556 is translated in response to the actuator 512 moving. Specifically, the actuator 512 is connected to the cammed body 556 via a shaft 564, such that movement of the actuator 512 results in corresponding movement of the cammed body 556. The actuator 512 and the cammed body 556 (and therefore the shaft 564) move along an actuator axis 568 that is perpendicular to the valve axis 528. A pin 572 is coupled to the main body 504 and slidably supports the cammed body 556 for movement along the actuator axis 568.

With reference to FIGS. 4 and 5, the valve 508 is a poppet-style valve and is movable between a first or closed position (FIG. 4), in which the valve 508 seats against the main body 504, and a second or open position (FIG. 5), in which the valve 508 is spaced away from the main body 504. Specifically, in the closed position, the valve 508 abuts the second seal 536, whereas the valve 508 is spaced away (or released) from the second seal 536 in the open position. When the actuator 512 is moved to a depressed state (FIG. 5), the cammed body 556 slides against the inner periphery of the elongated slot 552 of the stem 548 and exerts a force on the stem 548 to move the valve 508 along the valve axis 528 to the open position. When the actuator 512 is released, the actuator 512 returns to its default, extended state (FIG. 4) automatically without a spring. In fact, the actuator 512 has shape memory that enables the actuator 512 to return to the extended state after being elastically deformed in response to an external force is exerted on the actuator 512 (e.g., moved to the depressed state). The lack of a spring in the valve assembly 500 and few moving parts is beneficial for cleaning purposes. In some embodiments, a spring or biasing member may be provided to bias the actuator 512 to the extended state.

The valve assembly 500 may be removed or decoupled from the cap 400 when the cap 400 is not coupled to the bottle 200, as shown in FIG. 2. To remove the valve assembly 500 from the cap 400, the actuator 512 is moved to the depressed state and the valve assembly 500 is slid out from the first end 412 of the cap 400. This may be advantageous for cleaning purposes. Specifically, the cap 400 and the valve assembly 500 may be cleaned while separated from each other. In some instances, the components of the cap 400 and the valve assembly 500 are made of the same or similar materials as the bottle 200 and/or the nipple 300. In some instances, all components of the bottle 200, nipple, 300, the cap 400, and the valve assembly 500 are made of a dishwasher-safe material.

When an off-the-shelf nipple is coupled to an off-the-shelf bottle, the combination of the bottle and the nipple may form a single reservoir that holds fluid. The addition of the cap 400 (with the valve assembly 500) between the bottle 200 and the nipple 300 splits this single reservoir into two separate reservoirs R1 and R2 between which fluid may be optionally moved by gravitational force using the actuator 512 as explained herein. The bottle 200 defines a first reservoir R1 that may hold and store the fluid. There is a second reservoir R2 that is at least partially defined by the nipple 300 and the valve assembly 500. In some embodiments, the second reservoir R2 may also be partially defined by the cap 400 depending on the distance D of the cap 400. Specifically, if the second end 420 of the cap 400 extends beyond the valve assembly 500, then the second reservoir R2 is defined by a combination of the nipple 300, the valve 508, and the cylindrical body 424 of the cap 400. The first reservoir R1 is in fluid communication with the second reservoir R2.

During use, the cap 400 may be removed from the bottle 200 to fill the bottle 200 with the fluid (e.g., milk, baby formula, etc.), at which point the cap 400 can be threaded onto the bottle 200 via the threaded regions 216, 408. The reservoir R1 is now filled with the fluid. A user may invert the baby bottle 100, such that the fluid in the bottle 200 moves toward the valve assembly 500 under gravity. While holding the baby bottle 100 single-handed, the user may depress the actuator 512 to the depressed state using a finger of the user's hand holding the baby bottle 100, thereby moving the valve 508 to the open position and allowing the fluid to move beyond the valve assembly 500 toward the nipple 300. When the finger of the user's hand holding the baby bottle 100 releases the actuator 512, the valve 508 returns to the closed position, where a discrete amount of fluid is maintained in the second reservoir R2. The remaining fluid (if any) is stored in the first reservoir R1 and is inhibited from moving into the second reservoir R2 when the valve 508 is in the closed position. The discrete amount of fluid in the second reservoir R2 can be measured using the measurement indices 324 and, if desired, refined by repeatedly opening the valve 508 via the actuator 512. That is, if the user desires less fluid in the second reservoir R2, the baby bottle 100 is held upright and the valve 508 is momentarily moved to the open position to let some fluid move back to the first reservoir R1 under gravity. If, on the other hand, the user desires more fluid in the second reservoir R2, the baby bottle 100 is inverted and the valve 508 is momentarily moved to the open position to let some additional fluid from the first reservoir R1 move to the second reservoir R2 under gravity. When the actuator 512 is unactuated, fluid in each reservoir R1 and R2 remains in its respective reservoir regardless of an orientation of the baby bottle 100.

Once the desired amount of fluid is in the second reservoir R2, the user may hold the baby bottle 100 inverted for an infant to consume the discrete amount of fluid in the second reservoir R2 via the discharge port 304. Repeating this process allows the user to introduce precise and discrete amounts of fluid throughout a feeding cycle. The baby bottle 100 may be advantageous for the following reasons: (1) to track/record the amount of fluid an infant is receiving at given times (e.g., an amount of fluid consumed before the baby should be burped or otherwise take a feeding break), (2) to introduce the fluid from the first reservoir R1 in precise, discrete amounts via the second reservoir R2, and (3) to hold and operate the baby bottle 100 and the actuator 512 with one hand.

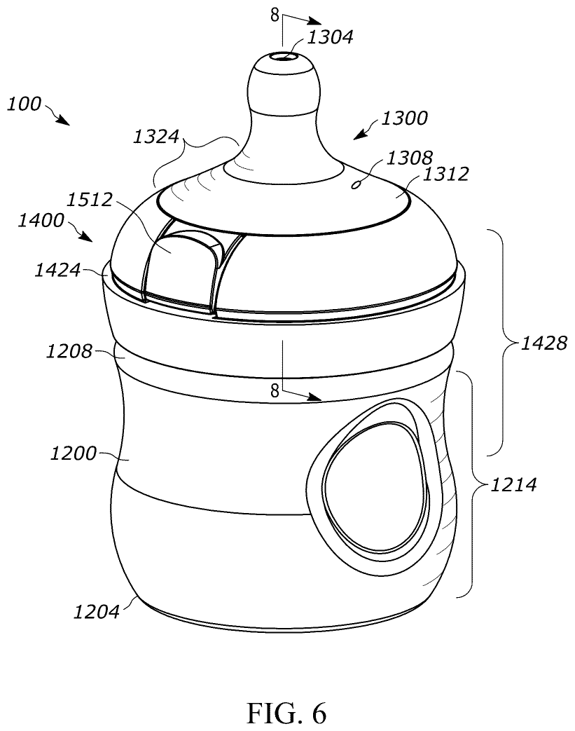

FIGS. 6-9 illustrate a baby bottle 1100 in accordance with another embodiment of the invention. The baby bottle 1100 is similar to the baby bottle 100 with similar features given like reference numerals, plus “1000”. The main difference between the baby bottle 1100 and the baby bottle 100 is a valve assembly 1500 that displaces a portion of the nipple 1300 to allow fluid to move between a first reservoir R1 and a second reservoir R2, as explained in further detail below.

FIG. 6 illustrates a baby bottle 1100 that is configured to hold and deliver fluid (e.g., milk, baby formula, etc.) to an infant. The baby bottle 1100 of the illustrated embodiment includes a bottle 1200, a nipple 1300, and a cap 1400. The bottle 1200 holds and stores any fluid in the baby bottle 1100, while the nipple 1300 is configured to discharge the fluid from the baby bottle 1100. Specifically, when the baby bottle 1100 is inverted (e.g., held substantially upside down-opposite orientation to that shown in FIG. 6), the nipple 1300 may deliver the fluid to an infant. That is, the illustrated baby bottle 1100 is a gravity-fed baby bottle, rather than a straw-fed baby bottle. The cap 1400 couples the nipple 1300 to the bottle 1200 and forms a water-tight seal therebetween.

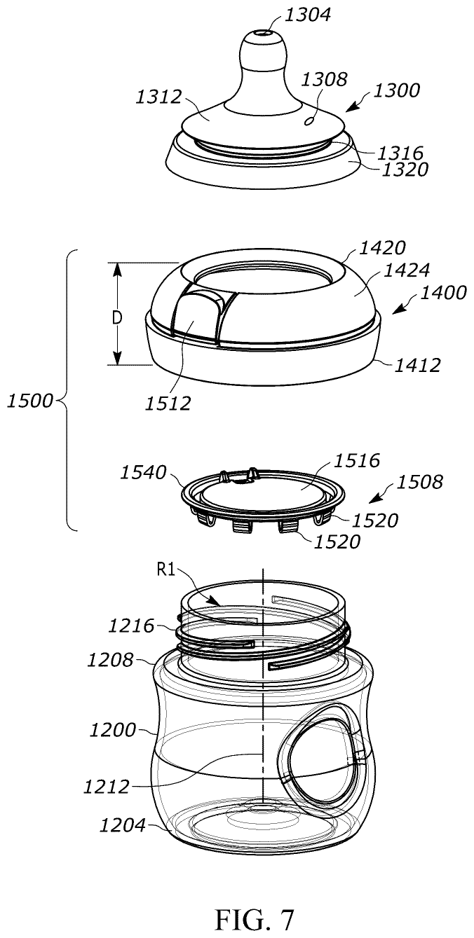

With reference to FIGS. 6 and 7, the bottle 1200 includes a closed or first end 1204, an open or second end 1208, and measurement indices 1214 (i.e., graduated markings) disposed along an outer periphery of the bottle 1200 and extending in a direction from the first end 1204 to the second end 1208. The bottle 1200 also defines a longitudinal axis 1212 extending between the first end 1204 and the second end 1208. In the illustrated embodiment, the measurement indices 1214 generally extend in a direction parallel to the longitudinal axis 1212. The bottle 1200 also includes a threaded region 1216 adjacent the second end 1208 for threadably mating with the cap 1400. In other embodiments, the bottle 1200 and the cap 1400 may be coupled together via other mechanisms, such as a snap-fit coupling, a bayonet-style coupling, a ball-and-sleeve coupling, and other similar quick-disconnect mechanisms.

The bottle 1200 of the illustrated embodiment is composed of hard plastic. Specifically, the bottle 1200 is composed of polypropylene, while in other embodiments, the bottle 1200 may alternatively be composed of glass, stainless steel, or other suitable materials. Still, in other embodiments, the bottle 1200 may be deformable and may be composed of a flexible material, such as silicone or other suitable materials.

With continued reference to FIGS. 6 and 7, the nipple 1300 includes a discharge port 1304 through which the fluid in the bottle 1200 may pass through. The discharge port 1304 may be a single pinhole, slot, a plurality of pinholes, or a combination thereof. The nipple 1300 also includes a check valve 1308 that selectively allows air from the atmosphere surrounding the baby bottle 1100 to enter inside the baby bottle 1100. The check valve 1308 is a one-way, duckbill style check valve that allows air to enter the baby bottle 1100 as the fluid is discharged from the baby bottle 1100 to balance pressure differentials between inside the baby bottle 1100 and outside the baby bottle 1100. Specifically, the check valve 1308 opens when the pressure inside the baby bottle 1100 is less than the pressure outside the baby bottle 1100 (i.e., atmosphere), allowing air to enter the baby bottle 1100.

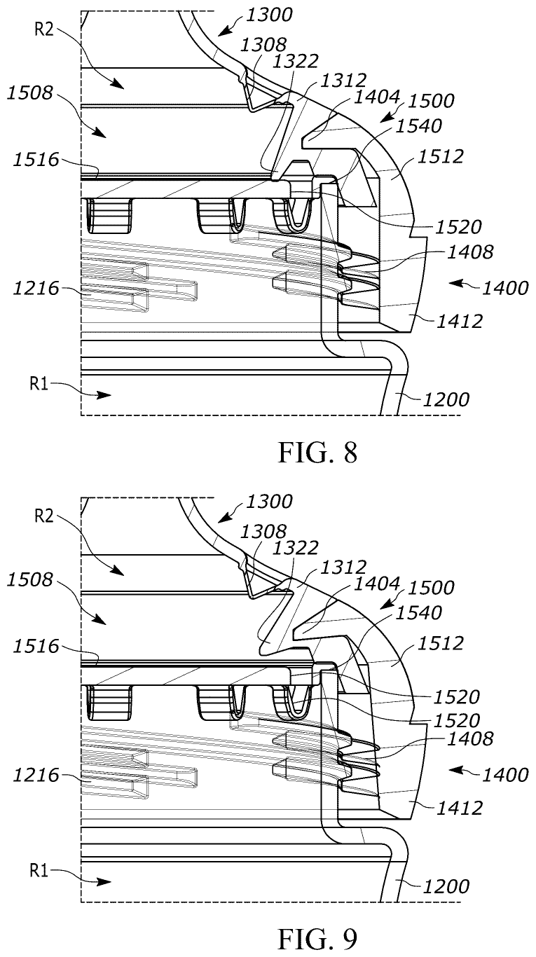

The nipple 1300 also includes a base 1312, a groove 1316, and a flange 1320. Both the groove 1316 and the flange 1320 extend circumferentially around the base 1312. The groove 1316 extends radially inward relative to the flange 1320 and receives a portion of the cap 1400. That is, the nipple 1300 couples to the cap 1400 via engagement between the groove 1316 and a corresponding projection 1404 of the cap 1400 (as best shown in FIG. 8). As explained in further detail below, the flange 1320 helps maintain a water-tight seal of the baby bottle 1100 to inhibit leaking of any fluid. The nipple 1300 also includes an annular projection 1322 disposed inside the nipple 1300. The annular projection 1322 encircles the inside of the nipple 1300 adjacent the base 1312. In other words, the annular projection 1322 extends 360 degrees. The nipple 1300 also includes measurement indices 1324 extending generally from the discharge port 1304 toward the base 1312. In the illustrated embodiment, the measurement indices 1324 are inverted relative to the measurement indices 1214 of the bottle 1200, such that the measurement indices 1324 are readable when the baby bottle 1100 is inverted (e.g., during feeding). In other embodiments, the measurement indices 1214, 1324 are both oriented in the same direction, such that the measurement indices 1214, 1324 are readable when the baby bottle 1100 is oriented upright.

The nipple 1300 of the illustrated embodiment is composed of a polymer. Specifically, the nipple 1300 is composed of silicone, while in other embodiments, the nipple 1300 may alternatively be composed of latex or other suitable materials.

With continued reference to FIGS. 6 and 7, the cap 1400 (i.e., attachment) includes a threaded region 1408 at a first end 1412 that threadably mates with the threaded region 1216 of the bottle 1200. That is, when first end 1412 of the cap 1400 is engaged with the second end 1208 of the bottle 1200, the cap 1400 (or the bottle 1200) may be rotated about the longitudinal axis 1212 in a clockwise direction to threadably couple the bottle 1200 and the cap 1400. The cap 1400 further includes a second end 1420. The projection 1404 (previously discussed as being received within the groove 1316 of the nipple 1300) is disposed at the second end 1420. Between the first end 1412 and the second end 1420 is a body 1424 (i.e., attachment housing) that may at least partially form a gripping portion 1428 of the baby bottle 1100. The bottle 1200 may also partially form the gripping portion 1428. The first end 412 and the second end 208 are spaced apart from each other a distance D (FIG. 7). In some embodiments, the distance D is between approximately 10 millimeters to approximately 40 millimeters. Specifically, the distance D is between approximately 29 millimeters to approximately 30 millimeters. More specifically, the distance D is approximately 23 millimeters.

With reference to FIGS. 7-9, the baby bottle 1100 further includes a valve assembly 1500 that is removably coupled between the bottle 200 and the nipple 1300. The valve assembly 1500 is disposed within the baby bottle 1100 when the bottle 1200, the nipple 1300, and the cap 1400 are coupled together. Generally speaking, the valve assembly 1500 selectively permits the fluid in the baby bottle 1100 to move from the bottle 1200 toward the nipple 1300, and vice versa.

With continued reference to FIGS. 7-9, the valve assembly 1500 includes a valve 1508 and an actuator 1512. The illustrated valve 1508 includes a disc 1516, a plurality of apertures 1520 disposed radially outward relative to the disc 1516, and an annular ring 1540 that extends radially outward from the plurality of apertures 1520. The annular ring 1540 abuts against the flange 1320 of the nipple 1300 to create a water-tight seal between the valve assembly 1500 and the nipple 1300. Specifically, the annular ring 1540 is situated between the bottle 1200 and the flange 1320 of the nipple 1300 to create the water-tight seal and inhibit any fluid from leaking through the interface between the nipple 300 and the bottle 200.

With reference to FIGS. 8 and 9, the annular projection 1322 of the nipple 1300 engages the disc 1516 of the valve 1508 to create a seal between the valve 1058 and the nipple 1300. The valve assembly 1500 is movable between a first or closed position (FIG. 8), in which the annular projection 1322 seats against the disc 1516, and a second or open position (FIG. 9), in which a portion of the annular projection 1322 is deformed and spaced away from the disc 1516. When the actuator 1512 is moved to a depressed state (FIG. 9), the actuator 1512 elastically deforms a portion of the nipple 1300 to temporarily interrupt the seal between the annular projection 1322 and the disc 1516 of the valve 1508. When the actuator 1512 is released, the actuator 1512 returns to its default, extended state (FIG. 8) automatically without a spring. The lack of a spring in the valve assembly 1500 and few moving parts is beneficial for cleaning purposes. In some embodiments, a spring or biasing member may be provided to bias the actuator 1512 to the extended state.

The valve 1508 may be removed from the bottle 1200, as shown in FIG. 7. This may be advantageous for cleaning purposes. Specifically, the cap 1400 and the valve 1508 may be cleaned while separated from each other.

The bottle 1200 defines a first reservoir R1 that may hold and store the fluid. There is a second reservoir R2 that is at least partially defined by the nipple 1300 and the valve 1508. In some embodiments, the second reservoir R2 may also be partially defined by the cap 1400 depending on the distance D of the cap 1400. Specifically, if the second end 1420 of the cap 1400 extends beyond the valve 1508, then the second reservoir R2 is defined by a combination of the nipple 1300, the valve 1508, and the body 1424 of the cap 1400. The first reservoir R1 is in fluid communication with the second reservoir R2.

During use, the cap 1400 may be removed from the bottle 1200 to fill the bottle 1200 with the fluid (e.g., milk, baby formula, etc.), at which point the cap 1400 can be threaded onto the bottle 1200 via the threaded regions 1216, 1408. The reservoir R1 is now filled with the fluid. A user may invert the baby bottle 1100, such that the fluid in the bottle 1200 moves toward the valve assembly 1500 under gravity. While holding the baby bottle 1100 single-handed, the user may depress the actuator 1512 to the depressed state using a finger of the user's hand holding the baby bottle 1100, thereby displacing the seal between the annular projection 1322 and the disc 1516. As a result, the fluid in the reservoir R1 is allowed to move to the second reservoir R2 via the plurality of apertures 1520. When the finger of the user's hand holding the baby bottle 1100 releases the actuator 1512, the annular projection 1322 reseats against the disc 1516, at which point a discrete amount of fluid is maintained in the second reservoir R2. The remaining fluid (if any) is stored in the first reservoir R1 and is inhibited from moving into the second reservoir R2 when the valve assembly 1500 is in the closed position. The discrete amount of fluid in the second reservoir R2 can be measured using the measurement indices 1324 and, if desired, refined by repeatedly pressing the actuator 512. That is, if the user desires less fluid in the second reservoir R2, the baby bottle 1100 is held upright and the valve assembly 1500 is momentarily moved to the open position to let some fluid move back to the first reservoir R1 under gravity. If, on the other hand, the user desires more fluid in the second reservoir R2, the baby bottle 1100 is inverted and the valve assembly 1500 is momentarily moved to the open position to let some additional fluid from the first reservoir R1 move to the second reservoir R2 under gravity.

Once the desired amount of fluid is in the second reservoir R2, the user may hold the baby bottle 1100 inverted for an infant to consume the discrete amount of fluid in the second reservoir R2 via the discharge port 1304. Repeating this process allows the user to introduce precise and discrete amounts of fluid throughout a feeding cycle. The baby bottle 1100 may be advantageous for the following reasons: (1) to track/record the amount of fluid an infant is receiving, (2) to introduce the fluid from the first reservoir R1 in precise, discrete amounts via the second reservoir R2, and (3) to hold and operate the baby bottle 1100 and the actuator 1512 with one hand.

Although the disclosure has been described in detail with reference to certain preferred embodiments, variations and modifications exist within the scope and spirit of one or more independent aspects of the disclosure as described. Various features and advantages of the disclosure are set forth in the following claims.

What is claimed is:

1. A baby bottle for holding and delivering a fluid, the baby bottle comprising:
a first reservoir configured for holding the fluid;
a second reservoir in fluid communication with the first reservoir; and
a valve assembly disposed between the first reservoir and the second reservoir, the valve assembly configured to enable the fluid to selectively move between the first reservoir and the second reservoir.

2. The baby bottle of claim 1, wherein the first reservoir defines a longitudinal axis about which a cap rotates to threadably couple to the first reservoir.

3. The baby bottle of claim 2, wherein the valve assembly includes an actuator that is moveable along a direction substantially perpendicular to the longitudinal axis.

4. The baby bottle of claim 3, wherein the actuator is moveable between an extended state and a depressed state using a finger of a user's hand holding the baby bottle, wherein the actuator is biased towards the extended state.

5. The baby bottle of claim 2, wherein the valve assembly includes a valve that is moveable between a first position and a second position along a direction parallel to the longitudinal axis, wherein the fluid is inhibited from moving between the first reservoir and the second reservoir when the valve is in the first position, and wherein the fluid is permitted to move between the first reservoir and the second reservoir under gravitation force when the valve is in the second position.

6. The baby bottle of claim 5, wherein the valve assembly includes a cammed body that slides against the valve to move the valve between the first position and the second position.

7. The baby bottle of claim 1, wherein the second reservoir includes a nipple, the nipple having at least one discharge port through which the fluid may exit the second reservoir and a check valve through which air may enter the second reservoir.

8. A baby bottle for holding and delivering a fluid, the baby bottle comprising:
a bottle defining a longitudinal axis and a first reservoir;
a cap removably coupled to the bottle;
a nipple defining a second reservoir that is in fluid communication with the first reservoir; and
a valve assembly disposed in the cap, the valve assembly including a valve that is moveable between a first position, in which the fluid is inhibited from moving between the first reservoir and the second reservoir, and a second position, in which the fluid is permitted to move between the first reservoir and the second reservoir under gravitation force.

9. The baby bottle of claim 8, wherein the nipple forms a seal with the cap.

10. The baby bottle of claim 8, wherein the valve assembly is removably coupled to the cap.

11. The baby bottle of claim 8, wherein the valve is moveable along a direction parallel to the longitudinal axis.

12. The baby bottle of claim 8, wherein the valve is a poppet-style valve.

13. The baby bottle of claim 8, wherein the valve assembly further includes:
an actuator that moves a direction substantially perpendicular to the longitudinal axis, and
a cammed body that moves in response to movement of the actuator and slides against the valve to move the valve between the first position and the second position.

14. The baby bottle of claim 13, wherein the actuator is movable between an extended state and a depressed state using a finger of a user's hand holding the baby bottle, wherein the actuator is biased towards the extended state.

15. The baby bottle of claim 13, wherein the valve includes a stem with an aperture, wherein the cammed body slides against an inner periphery of the aperture when moving the valve between the first position and the second position.

16. The baby bottle of claim 13, wherein the actuator extends through the cap.

17. An attachment configured to be coupled to a baby bottle for allowing a fluid to selectively move from a first reservoir of the baby bottle to a second reservoir of the baby bottle, the attachment comprising:
an attachment housing configured to be coupled between the first reservoir and the second reservoir; and
a valve assembly disposed in the attachment housing, wherein the valve assembly includes:
a main body configured to be removably coupled to the attachment housing,
a valve coupled to the main body and configured to be disposed between the first reservoir and the second reservoir of the baby bottle, wherein the valve is moveable between a closed position and an open position, and
an actuator coupled to the main body and configured to move the valve between the closed position and the open position.

18. The attachment of claim 17, wherein the main body defines a longitudinal axis along which the valve moves between the closed position, in which the valve seats against the main body, and the open position, in which the valve is spaced away from the main body.

19. The attachment of claim 17, wherein the main body includes a guide and the valve includes a stem that slides within the guide when the valve moves between the closed position and the open position.

20. The attachment of claim 17, wherein the actuator is coupled to a cammed body that moves in response to movement of the actuator and slides against the valve to move the valve between the closed position and the open position.
